(19) United States
(12) Patent Application Publication
(10) Pub. No.: US 2004/0237387 A1
(43) Pub. Date: Dec. 2, 2004

(54) Biodegradable mat with additives and method

(75) Inventor: Carter Benson McCamy, Adamstown, MD (US)

Correspondence Address: NIXON & VANDERHYE, PC, 1100 N GLEBE ROAD, 8TH FLOOR, ARLINGTON, VA, 22201-4714, US

(73) Assignee: Environmental Quality Resources, L.L.C., Gaithersburg, MD

(21) Appl. No.: 10/842,426

(22) Filed: May 11, 2004

Related U.S. Application Data
(60) Provisional application No. 60/469,401, filed on May 12, 2003.

(51) Int. Cl. A01G 7/00

(52) U.S. Cl. 47/9

(57) ABSTRACT

A biodegradable mat promotes growth and health of vegetation. The mat includes a plurality of biodegradable fibers weaved into a mat sized and shaped for placement adjacent vegetation. At least one of a fertilizer and an herbicide are broadcast spread on the mat. A bittering agent is adhered to the mat, which also serves to adhere the fertilizer and/or herbicide to the mat. The resulting construction retains moisture, releases fertilizer, blocks soils from weed seeds, kills emergent weeds below the mat, and resists foraging by deer and rodents. The mat is easy to transport and handle, and installation requires considerably less labor than conventional mulch.

### CROSS-REFERENCES TO RELATED APPLICATIONS

This application claims the benefit of U.S. Provisional Patent Application Ser. No. 60/469,401, filed May 12, 2003, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates to a biodegradable mat for promoting growth and health of vegetation.

Improved plant growth and soil enrichment are important objectives in the plant industry. For new installations, particularly trees and shrubs, the industry has utilized geotextile fabrics as mats, coir mats without additives, conventional mulch, recycled rubber shred mats and the like. The geotextile fabrics, however, are not biodegradable and are incapable of sufficiently storing moisture. The coir mats, although biodegradable, lack necessary additives such as fertilizer or herbicide and the like to promote proper growth and health of the plants. Conventional mulch is labor intensive for installation, and rubber shred mats are similarly not biodegradable. Additional prior art products are described in U.S. Pat. No. 6,195,935 (the '935 patent), the disclosure of which is hereby incorporated by reference.

The '935 patent attempts to overcome these problems in the prior art products with a mat including a multi-layer construction, wherein sturdy top and bottom layers are connected together to contain a middle layer of granular material. This construction is difficult and expensive to manufacture, and handling of the multi-layer construction is burdensome, particularly with the loose granular middle layer.

### BRIEF SUMMARY OF THE INVENTION

The present invention provides a biodegradable mat incorporating additives that promote the growth and health of vegetation. After the mat is weaved into a desired shape, fertilizer and/or an herbicide in pellet form are broadcast spread on the mat. Subsequently, a bittering agent is applied to the mat that adheres the fertilizer and/or herbicide in place. When dry, the mat has a simplified single-layer construction that is easy to handle and transport and easy to install.

In an exemplary embodiment of the invention, a method is provided for manufacturing a biodegradable mat for promoting growth and health of vegetation. The method includes the steps of (a) weaving biodegradable fibers, such as coir fibers, into a mat sized and shaped for placement adjacent vegetation; (b) broadcast spreading at least one of a fertilizer and an herbicide on the mat; and (c) applying, e.g., by spraying, a bittering agent to the mat, wherein the applying step adheres the fertilizer and/or herbicide to the mat. Step (b) may be practiced by broadcast spreading the fertilizer and/or herbicide at a rate of about 0.32 oz. per square foot of mat. Prior to step (c), the method may include the step of forming the bittering agent by mixing a bittering powder, such as denatonium benzoate, within a liquid latex sticking agent.

In another exemplary embodiment of the invention, a biodegradable mat for promoting growth and health of vegetation includes a plurality of biodegradable fibers weaved into a mat sized and shaped for placement adjacent vegetation. At least one of a fertilizer and an herbicide is broadcast spread on the mat, and a bittering agent is adhered to the mat. The bittering agent serves to adhere the fertilizer and/or herbicide to the mat.

### BRIEF DESCRIPTION OF THE DRAWINGS

These and other aspects and advantages of the present invention will be described in detail with reference to the accompanying drawings, in which:

FIG. 1 illustrates an exemplary mat of the invention installed around a tree; and

FIG. 2 is a flow diagram illustrating the method of manufacturing the mat of the present invention.

### DETAILED DESCRIPTION OF THE INVENTION

As discussed above, coir mats without additives have been used for sediment control and the like. The mat is constructed by weaving coir fibers, which are derived from coconut husks, into a desired size and shape. The construction of such mats is known, and details thereof will not be further described. Although the invention will be described in the context of a mat constructed using coir fibers, it should be appreciated that other suitable biodegradable fibers may be used, and the invention is not necessarily meant to be limited to the described application.

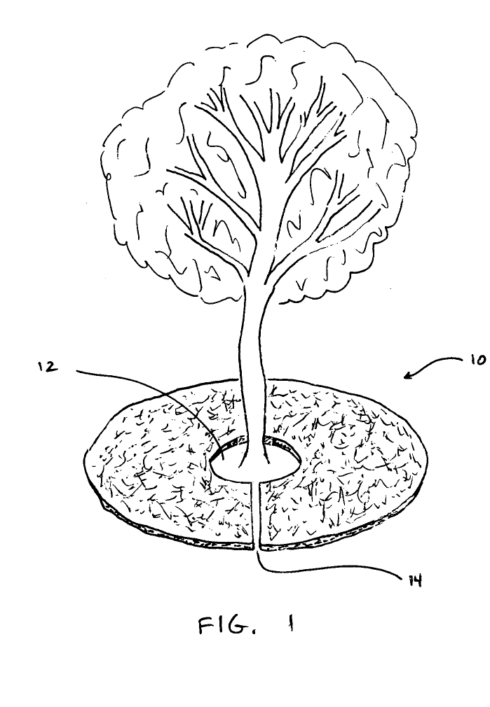

With reference to FIG. 1, the biodegradable mat 10 of the present invention is composed of biodegradable fibers, preferably coir fibers, densely woven into a desired shape and size. In an exemplary application, the mat 10 is shaped and sized to fit around a tree, including a central opening 12 and a radial slit 14 for installation around the tree. The assembled mat is preferably about one inch thick. Typically, the central opening 12 is about one-fourth the size of the mat diameter. For example, with a mat constructed in a generally circular configuration as shown in FIG. 1, with a diameter of about sixteen inches, the central opening 12 should be about four inches in diameter.

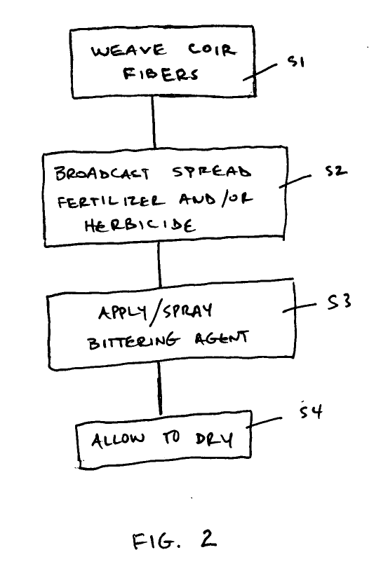

Additives are introduced after the mat 10 is manufactured. With reference to FIG. 2, in step S1, the fibers are densely woven into a mat suitably sized and shaped for placement adjacent vegetation. At least one of a fertilizer and herbicide in pellet form is broadcast spread on the mat at a rate of about 0.32 ounces per square foot mat (step S2). One suitable natural herbicide and fertilizer is made from corn gluten, which has been tested as safe for woody plants. An example of suitable material is corn gluten meal described in U.S. Pat. Nos. 5,030,268 and RE34,594, the contents of which are hereby incorporated by reference.

A bittering agent is formed by mixing a bittering powder such as denatonium benzoate, within a liquid latex sticking agent. The sticking agent may be any known material suitable for the described purpose, where one exemplary sticking agent is a mix of corn syrup and water. This bittering agent can be applied by being sprayed over the mat (step S3). The bittering agent is then allowed to dry (step S4), which serves to adhere the fertilizer and/or herbicide to the mat.

The resulting mat with additives is easily transported and handled and easily installed. The mat provides a one-step installation with materials that are renewable and 100% biodegradable. The mat will retain moisture, release fertilizer, block soils from weed seeds, and kill emergent weeds below the mat. The bittering agent is absorbed through the soil and plant roots via a systemic methodology causing the plant to taste bitter, which reduces the likelihood of foraging by deer and rodents.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of manufacturing a biodegradable mat for promoting growth and health of vegetation, the method comprising:
(a) weaving biodegradable fibers into a mat sized and shaped for placement adjacent vegetation;
(b) broadcast spreading at least one of a fertilizer and an herbicide on the mat; and
(c) applying a bittering agent to the mat, wherein the applying step adheres the fertilizer and/or herbicide to the mat.

2. A method according to claim 1, wherein step (b) is practiced by broadcast spreading the fertilizer and/or herbicide at a rate of about 0.32 oz. per square foot of mat.

3. A method according to claim 1, wherein, prior to step (c), the method comprises forming the bittering agent by mixing a bittering powder within a liquid latex sticking agent.

4. A method according to claim 3, wherein the bittering powder consists of denatonium benzoate.

5. A method according to claim 1, wherein step (a) is practiced by weaving coir fibers.

6. A method according to claim 1, wherein step (c) is practiced by spraying the bittering agent on the mat.

7. A biodegradable mat manufactured according to the method of claim 1.

8. A biodegradable mat for promoting growth and health of vegetation, the biodegradable mat comprising:
a plurality of biodegradable fibers weaved into a mat sized and shaped for placement adjacent vegetation;
at least one of a fertilizer and an herbicide broadcast spread on the mat; and
a bittering agent adhered to the mat, wherein the bittering agent adheres the fertilizer and/or herbicide to the mat.

9. A biodegradable mat according to claim 8, wherein the fertilizer and/or herbicide is broadcast spread at a rate of about 0.32 oz. per square foot of mat.

10. A biodegradable mat according to claim 8, wherein the bittering agent comprises a mix of a bittering powder and a liquid latex sticking agent.

11. A biodegradable mat according to claim 10, wherein the bittering powder consists of denatonium benzoate.

12. A biodegradable mat according to claim 8, wherein the biodegradable fibers comprise coir fibers.

13. A biodegradable mat according to claim 8, wherein the mat is generally circular in shape and comprises a central opening therein sized to fit around a tree trunk.

14. A biodegradable mat according to claim 8, wherein the mat is about one inch thick.

15. A biodegradable mat for promoting growth and health of vegetation, the biodegradable mat comprising:
a plurality of coir fibers weaved into a mat sized and shaped for placement adjacent vegetation;
a combined fertilizer and herbicide in pellet form broadcast spread on the mat; and
a bittering agent including a bittering powder mixed with a liquid latex sticking agent sprayed on the mat, wherein the bittering agent adheres the fertilizer and/or herbicide to the mat.

16. A biodegradable mat according to claim 15, wherein the fertilizer and/or herbicide is broadcast spread at a rate of about 0.32 oz. per square foot of mat.

17. A biodegradable mat according to claim 15, wherein the bittering powder consists of denatonium benzoate.

18. A biodegradable mat according to claim 15, wherein the mat is generally circular in shape and comprises a central opening therein sized to fit around a tree trunk.

19. A biodegradable mat according to claim 15, wherein the mat is about one inch thick.
